(19) United States
(12) Patent Application Publication
(10) Pub. No.: US 2025/0016637 A1
(43) Pub. Date: Jan. 9, 2025

(54) METHOD FOR INFORMATION PROCESSING, TERMINAL DEVICE AND CHIP

(71) Applicant: GUANGDONG OPPO MOBILE TELECOMMUNICATIONS CORP., LTD., Dongguan (CN)

(72) Inventors: Xin YOU, Dongguan (CN); Jiangsheng FAN, Dongguan (CN); Haitao LI, Dongguan (CN); Xue LIN, Dongguan (CN)

(21) Appl. No.: 18/895,504

(22) Filed: Sep. 25, 2024

Related U.S. Application Data
(63) Continuation of application No. PCT/CN2022/083192, filed on Mar. 25, 2022.

(51) Int. Cl. H04W 36/00; H04W 36/08

(52) U.S. Cl. CPC H04W 36/0072; H04W 36/0061; H04W 36/08

(57) ABSTRACT

A method for processing information is applicable to a terminal device, and the method includes: receiving configuration information of candidate cells; and determining a time advance based on the configuration information of the candidate cells. The terminal device includes: a processor and a memory, wherein the memory stores one or more computer program, and the processor, when loading and running the one or more computer program stored in the memory, causes the terminal device to perform the method. A chip includes: a processor, wherein the processor, when loading and running one or more computer programs stored in a memory, causes a device equipped with the chip to perform the method.

### CROSS-REFERENCE TO RELATED APPLICATION

This application is a continuation application of International Application No. PCT/CN2022/083192, filed on Mar. 25, 2022, the entire disclosure of which is hereby incorporated herein by reference.

### TECHNICAL FIELD

The present disclosure relates to the field of communication and, and in particular, relates to a method for processing information, a terminal device and a chip.

### RELATED ART

New radio (NR) systems support the handover process of user equipment (UE) in connected state. For example, handover is performed based on Layer 1 (L1) or Layer 2 (L2) signaling. In the case that the UE and the target cell are not synchronized, the UE still needs to acquire the time advance of the target cell through random access upon receiving the handover command, which increases the handover delay.

### SUMMARY

Embodiments of the present disclosure provide a method for processing information, terminal device and a chip.

Embodiments of the present disclosure provide a method for processing information. The method is applicable to a terminal device, and includes:
receiving configuration information of candidate cells; and
determining a time advance based on the configuration information of the candidate cells.

Embodiments of the present disclosure provide a terminal device. The terminal device includes a processor and a memory. The memory stores one or more computer programs, and the processor, when loading and running the one or more computer programs stored in the memory, causes the terminal device to perform the above method.

Embodiments of the present disclosure provide a chip. The chip includes a processor configured to perform the above method.

Specifically, the chip includes a processor. The processor, when loading and running one or more computer programs stored in a memory, causes a device equipped with the chip to perform the above method.

### BRIEF DESCRIPTION OF DRAWINGS

FIG. 1 is a schematic diagram of an application scenario according to some embodiments of the present disclosure;

FIG. 2 is a schematic diagram of a handover process based on an Xn interface;

FIG. 3 is a schematic flowchart of a method for processing information according to some embodiments of the present disclosure;

FIG. 4 is a schematic block diagram of a terminal device according to some embodiments of the present disclosure;

FIG. 5 is a schematic block diagram of a terminal device according to some embodiments of the present disclosure;

FIG. 6 is a schematic block diagram of a communication device according to some embodiments of the present disclosure;

FIG. 7 is a schematic block diagram of a chip according to some embodiments of the present disclosure; and

FIG. 8 is a schematic block diagram of a communication system according to some embodiments of the present disclosure.

### DETAILED DESCRIPTION

The technical solutions in the embodiments of the present disclosure are to be described below in conjunction with the accompanying drawings in the embodiments of the present disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an NR evolution system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN) system, a wireless fidelity (Wi-Fi) system, a 5^{th} Generation (5G) system, or other communication systems.

Typically, traditional communication systems support a limited number of connections and are easy to implement. However, with the development of communication technologies, mobile communication systems support not only traditional communication but also, for example, device-to-device (D2D) communications, machine-to-machine (M2M) communications, machine-type communication (MTC), vehicle-to-vehicle (V2V) communications, or vehicle to everything (V2X) communications, or the like, and embodiments of the present disclosure are also applicable to these communication systems.

In one possible implementation, the communication system in the embodiments of the present disclosure is applicable to a carrier aggregation (CA) scenario, or a dual connectivity (DC) scenario, or a standalone (SA) deployment scenario.

The communication system according to the embodiments of the present disclosure is applicable to an unauthorized spectrum, wherein the unauthorized spectrum can also be considered as a shared spectrum. Alternatively, the communication system in the embodiments of the present disclosure is also applicable to an authorized spectrum, wherein the authorized spectrum may also be considered as an unshared spectrum.

Hereinafter, various embodiments of the present disclosure are described in conjunction with network device and terminal device, wherein the terminal device is also referred to as a UE, an access terminal, a subscriber unit, a subscriber station, a mobile station, a mobile console, a remote station, a remote terminal, a mobile device, a user terminal, a terminal, a wireless communication device, a user agent, a user device, or the like.

The terminal device is a station in a WLAN (Station, ST), may be a cellular phone, a cordless phone, a Session Initiation Protocol (SIP) phone, a wireless local loop (WLL) station, a personal digital assistant (PDA) device, a handheld devices with wireless communication, a computing device or other processing devices connected to a wireless modem, an in-vehicle device, a wearable device, a terminal device in a next-generation communication system such as an NR network, or a terminal device in a future evolved public land mobile network (PLMN).

In some embodiments of the present disclosure, the terminal device may be deployed on land, including indoors or outdoors, handheld, wearable, or vehicle-mounted. The terminal device may also be deployed on water (e.g., on ships), and in the air (e.g., on aircrafts, balloons, or satellites).

In some embodiments of the present disclosure, the terminal device is a mobile phone, a tablet computer (Pad), a computer with a wireless transceiver function, a virtual reality (VR) terminal device, an augmented reality (AR) terminal device, a wireless terminal device in industrial control, a wireless terminal device in self driving, a wireless terminal device in remote medical systems, a wireless terminal device in smart grid, a wireless terminal device in transportation safety, a wireless terminal device in smart city, or a wireless terminal device in smart home.

By way of example rather than limitation, in some embodiments of the present disclosure, the terminal device may also be a wearable device. The wearable device may also be referred to as a wearable intelligent device, which is a general term of wearable devices for applying wearable technology to intelligently design and development of daily wear, such as glasses, gloves, watches, clothing and shoes. A wearable device is a portable device that is worn directly on the body or integrated into the user's clothing or accessories. The wearable device is not only a hardware device, but also can achieve powerful functions through software support as well as data interaction and cloud interaction. Generalized wearable smart devices include full-function and large-sized devices that can achieve complete or partial function not relying on a smartphone, such as a smartwatch or smart glasses, or the like, as well as devices that only focus on a specific type of application functions and need to be used in conjunction with other devices such as smartphones, such as various types of smart bracelets and smart jewelries for monitoring physical signs.

In some embodiments of the present disclosure, the network device may be a device for communicating with the mobile device, and the network device may be an access point (AP) in WLAN, a base transceiver station (BTS) in GSM or CDMA, a Node B (NB) in WCDMA, and may also be an evolved Node B (eNB or eNodeB) in LTE, or a relay station or access point, or an in-vehicle device, a wearable device, and a network device in an NR network (gNB), or a network device in a future evolved PLMN network or a network device in an NTN network, or the like.

By way of example rather than limitation, in the embodiments of the present disclosure, the network device has mobile characteristics, e.g., the network device may be a mobile device. Optionally, the network device may be a satellite or a balloon station. For example, the satellite may be a low Earth orbit (LEO) satellite, a medium Earth orbit (MEO) satellite, a geostationary Earth orbit (GEO) satellite, a high elliptical orbit (HEO) satellite, or the like. Optionally, the network device may also be a Node B deployed at a location such as land and water.

In some embodiments of the present disclosure, the network device provides services for a cell, and the terminal device communicates with the network device over the transmission resources (e.g., frequency domain resources, or spectrum resources) used by the cell. The cell may be a cell corresponding to the network device (e.g., a Node B), and the cell may belong to a macro Node B or belong to the Node B corresponding to the small cell. The small cell here includes a metro cell, a micro cell, a pico cell, a femto cell, or the like. These small cells herein are all characterized by a small coverage area and low transmit power, and are suitable for the provision of high-rate data transmission services.

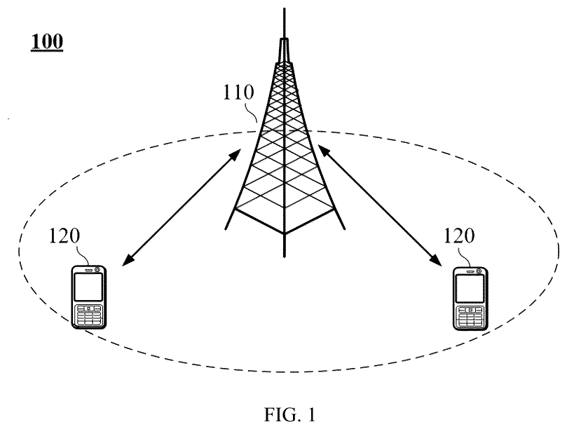

FIG. 1 exemplarily illustrates a communication system 100. The communication system includes a network device 110 and two terminal devices 120. In some embodiments, the communication system 100 includes a plurality of network devices 110, and terminal devices 120 in other quantities are included within the coverage of each of the network devices 110, which is not limited in the embodiments of the present disclosure.

In some embodiments, the communication system 100 also includes other network entities such as a mobility management entity (MME) or an access and mobility management function (AMF), which is not limited in the embodiments of the present disclosure.

The network device further includes an access network device and a core network device. That is, the wireless communication system also includes a plurality of core networks configured to communicate with the access network device. The access network device may be an eNB or e-NodeB, a micro Node B (also known as “small Node B”), pico Node B, access point (AP), transmission point (TP), or new generation Node B (gNodeB) in a long-term evolution (LTE) system, a next generation (NR) (mobile communication system) system, or an authorized auxiliary access long-term evolution (LAA-LTE) system.

It is understandable that devices having communication functions in the network/system in the embodiments of the present disclosure may be referred to as communication devices. Taking the communication system illustrated in FIG. 1 as an example, the communication device includes a network device and a terminal device having communication functions, and the network device and the terminal device are specific devices in the embodiments of the present disclosure, which are not repeated herein. The communication device also includes other devices in the communication system, such as network controllers, mobility management entities, and other network entities, which are not limited in the embodiments of the present disclosure.

It is understandable that the terms “system” and “network” are often used interchangeably herein. The term “and/or” in the present disclosure is merely intended to describe an association relationship of associated objects, indicating three relationships therebetween. For example, the phrase “A and/or B” means (A), (B), or (A and B). In addition, the symbol “/” herein generally indicates that the associated objects are in an “or” relationship.

It is understandable that the “indicate” mentioned in the embodiments of the present disclosure may be a direct indication, an indirect indication, or an indication of an association relationship. For example, A indicating B means that A directly indicates B, such as B can be accessed through A, A indicating B also means that A indirectly indicates B, such as A indicates C, and B can be accessed through C, and A indicating B also means that an association relationship exists between A and B.

In the description of the embodiments of the present disclosure, the term “corresponding” may indicate a direct or indirect corresponding relationship between the two, or an association relationship between the two, or a relationship between indicating and being indicated, configuring and being configured, and the like.

For ease of understanding of the technical solutions according to the embodiments of the present disclosure, the following describes the relevant technologies according to the embodiments of the present disclosure. The following relevant technologies may be combined with the technical solutions according to the embodiments of the present disclosure as an optional option, which all belong to the scope of protection of the embodiments of the present disclosure.

### Handover

Like the LTE system, the NR system supports a handover process (also referred to as a handover procedure) for a UE in a connected state. In the case that a user who is using the network service moves from one cell to another, or in the case that wireless transmission service load is adjusted, operation maintenance is activated or equipment fails, the system has to transfer a communication link between a user and a source cell to a new cell, i.e., the handover process is executed, to ensure the continuity of the communication and the quality of service.

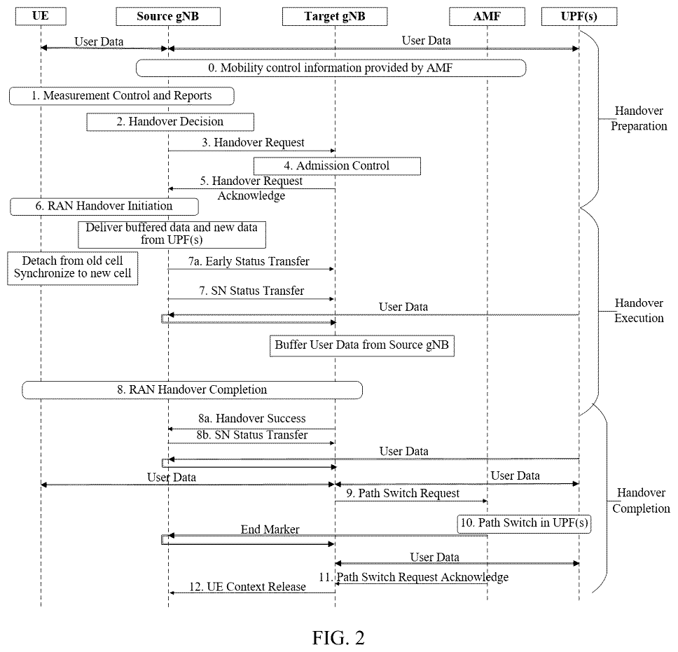

Referring to FIG. 2, an Xn interface-based handover process is used as an example for description. The handover process may include the following stages.

(1) Handover preparation, including measurement control, measurement reporting, handover request, and handover acknowledgement. The handover acknowledgement message includes a handover command generated by a target cell. The source cell is not allowed to make any modification to the handover command generated by the target cell, but is allowed to directly forward the handover command to the UE. Taking the source cell being a source gNB and the target cell being a target gNB as an example, the handover preparation may specifically include the following steps.

Step 0: An AMF provides mobility control information. For example, a UE context within the source gNB contains information regarding roaming and access restrictions which are provided either in connection establishment or in the last time advance update.

Step 1: Measurement control and reports. For example, the source gNB configures the UE measurement procedures and the UE reports according to the measurement configuration.

Step 2: Handover decision. For example, the source gNB decides, based on measurement report and radio resource management (RRM) information, to hand over the UE.

Step 3: Handover request. The source gNB issues a handover request message to the target gNB by a transparent radio resource management (RRC) container with necessary information to prepare the handover at the target side.

Step 4: Admission control. For example, the admission control may be performed by the target gNB.

Step 5: Handover request acknowledgement. For example, the target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a dual active protocol stack (DAPS) handover is accepted.

(2) Handover execution, including: execution of the handover process by the UE immediately in response to receiving the handover command, that is, disconnection of the UE from the source cell and connection of the UE to the target cell, e.g., performing random access, sending the RRC handover completion message to the target GNB, or the like; serial number (SN) state transfer; and data forwarding. Taking the source cell being a source gNB and the target cell being a target gNB as an example, the handover execution may specifically include the following steps.

Step 6: radio access network (RAN) handover initiation. For example, the source gNB triggers a Uu interface-based handover by sending an RRC reconfiguration message to the UE, wherein the RRC reconfiguration message contains the information required to access the target cell.

Step 7a: Early status transfer (EST). For example, a data radio bearer (DRB) configured with DAPS, the source gNB sends an EST message.

Step 7: SN status transfer. For the DRBs not configured with DAPS, the source gNB sends an SN status transfer message to the target gNB to convey the uplink PDCP SN receiver status and the downlink PDCP SN transmitter status of DRBs for which PDCP status preservation applies.

(3) Handover completion: the target cell performing path handover with the AMF and user plane function (UPF) to release the UE context of the source base station. Taking the source cell being a source gNB and the target cell being a target gNB as an example, the handover completion may include the following steps.

Step 8: RAN handover completion. The UE synchronizes to the target cell and completes the RRC handover procedure by sending RRC reconfiguration complete message to target gNB.

Step 8a: Handover success. In the case of a DAPS handover, the target gNB sends the handover success message to the source gNB to inform that the UE has successfully accessed the target cell.

Step 8b: SN status transfer. As feedback, the source gNB sends the SN status transfer message for DRBs configured with DAPS for which the description in step 7 applies.

Step 9: Path switch request. The target gNB sends a path switch request message to the AMF to trigger 5GC (5G core network) to switch the DL data path towards the target gNB and to establish an NG-C interface instance towards the target gNB.

Step 10: Path switch in UPF(s). 5GC switches the DL data path towards the target gNB. The UPF sends one or more “end marker” packets on the old path to the source gNB per PDU session/tunnel and then can release any U-plane/TNL resources towards the source gNB.

Step 11: Path switch request acknowledge. The AMF confirms the path switch request message with the path switch request acknowledge message.

Step 12: UE context release. Upon reception of the path switch request acknowledge message from the AMF, the target gNB sends the UE context release to inform the source gNB of the success of the handover. The source gNB can then release radio and C-plane related resources associated to the UE context. Any ongoing data forwarding may continue. L1 and/or L2 handover

In order to reduce the delay caused by handover, NR R18 supports handover based on L1 and/or L2. The handover based on L1 and/or L2 mainly applies for intra-central unit (CU) scenarios, where the handover is performed based on L1 or L2 signaling without any change in the CU (PDCP/key).

For L1 and/or L2 handover, in the case that the UE and the target cell are not synchronized, the UE still needs to acquire the time advance of the target cell by random access, then the handover delay is greatly increased by the random access procedure. In some embodiments of the present disclosure, the UE acquires the time advance in advance.

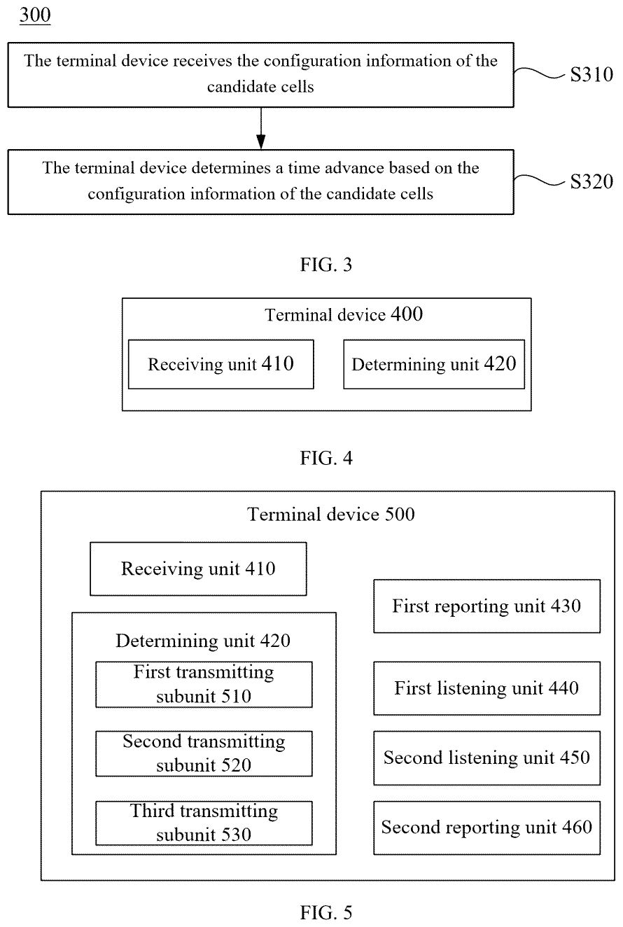

FIG. 3 is a schematic flowchart of a method for processing information 300 according to some embodiments of the present disclosure. Optionally, the method is applicable to the system shown in FIG. 1, which is, however, not limited thereto. The method is applicable to a terminal device in the system, and includes at least some of the following steps.

S310, the terminal device receives configuration information of candidate cells.

S320, the terminal device determines a time advance based on the configuration information of the candidate cells.

In some embodiments of the present disclosure, the terminal device receives an RRC reconfiguration message from a network device, such as a source cell. The RRC reconfiguration message includes the configuration information of the candidate cells. The terminal device determines the time advance used by the terminal device in the candidate cell prior to handover based on the received configuration information of the candidate cells. The configuration information of the candidate cells includes configuration information of one or more candidate cells. The plurality of candidate cells include one or more target cells.

In some embodiments, determining the time advance based on the configuration information of the candidate cells includes: transmitting a first reference signal to at least one of the candidate cells based on the configuration information of the candidate cells, wherein the first reference signal is configured to determine the time advance.

For example, the configuration information of that candidate cells includes an identifier of a candidate cell, and the terminal device transmits the first reference signal to the candidate cell. Further, for example, the configuration information includes identifiers of N candidate cells, wherein N is a positive integer greater than or equal to one. The terminal device transmits the first reference signal to the N candidate cells, or the terminal device transmits the first reference signal to some of the N candidate cells.

In some embodiments, transmitting the first reference signal to at least one of the candidate cells based on the configuration information of the candidate cells includes: transmitting the first reference signal to at least one of the candidate cells in the case that a first time period has elapsed since the terminal device receiving the configuration information of the candidate cells.

In some embodiments, the first time period is determined by a first timer, a start point of the first time period is a moment that the terminal device starts the first timer in response to receiving the configuration information of the candidate cells, and an end point of the first time period is a moment that the terminal device transmits the first reference signal to at least one of the candidate cells in response to timeout of the first timer.

For example, the terminal device starts the first timer in response to receiving the configuration information of the candidate cells. The duration of the first timer is pre-set or network-configured. In response to the timeout of the first timer, the terminal device transmits the first reference signal to at least one of the candidate cells.

In some embodiments, each of the candidate cells corresponds to a first timer. For example, the terminal device, in response to receiving the configuration information of the candidate cells, activates a plurality of first timers in the case that the configuration information includes the identifiers of the plurality of candidate cells. For example, in the case that the configuration information includes the identifiers of N candidate cells, N or M first timers are activated, wherein M is a positive integer less than N.

In some embodiments, the duration of the first timer is related to the movement trajectory of the terminal device and the coverage of the candidate cell. For example, for a terminal device with a particular movement trajectory, the network device triggers the transmission of the first reference signal in the case that the terminal device is about to and/or has just arrived at the coverage of that cell.

In some embodiments, determining the time advance based on the configuration information of the candidate cells includes: transmitting a first reference signal to at least one of the candidate cells based on the configuration information of the candidate cells and a first condition, wherein the first reference signal is configured to determine the time advance.

In some embodiments, the first condition includes at least one of the following items:
signal quality of the source cell is less than or equal to a first threshold; or
signal quality of the candidate cell is greater than or equal to the second threshold.

In some embodiments of the present disclosure, the first threshold is a source cell threshold, and the second threshold is a candidate cell threshold. The terminal device determines, based on whether the source cell satisfies the first condition, whether to transmit the first reference signal, determines, based on whether the candidate cell satisfies the first condition, whether to transmit the first reference signal, or determines, based on whether both the source cell and the candidate cell satisfy the first condition, whether to transmit the first reference signal. In the case that the signal quality of the source cell is poor, for example, the signal quality of the source cell is less than or equal to the first threshold, the source cell is considered to satisfy the first condition. In the case that the signal quality of the candidate cell is good, for example, the signal quality of the candidate cell is greater than or equal to the second threshold, the candidate cell is considered to satisfy the first condition.

In some embodiments, transmitting the first reference signal to at least one of the candidate cells based on the configuration information of the candidate cells and the first condition includes at least one of:
transmitting the first reference signal to all candidate cells in response to the signal quality of the source cell being less than or equal to the first threshold;
transmitting the first reference signal to candidate cells whose signal quality is greater than or equal to the second threshold in response to the signal quality of the candidate cells being greater than or equal to the second threshold; or
transmitting the first reference signal to candidate cells whose signal quality is greater than or equal to the second threshold in response to the signal quality of the source cell being less than or equal to the first threshold and the signal quality of the candidate cell being greater than or equal to the second threshold.

For example, in the case that the signal quality of the source cell is less than or equal to the first threshold, the terminal device needs handover, and the terminal device transmits the first reference signal to all the N candidate cells to acquire the time advance in advance, thereby reducing the handover delay during the handover procedure caused due to acquiring the time advance by performing the random access procedure. In the case that the signal quality of the source cell is greater than the first threshold, the terminal device does not need handover and the terminal device does not transmit the first reference signal to the candidate cells. In this way, it is not necessary to compare the signal quality of the candidate cells.

For example, in the case that the signal quality of M candidate cells of the N candidate cells is greater than or equal to the second threshold, the first reference signal is transmitted to one or more of the M candidate cells.

For example, in the case that the signal quality of the source cell is less than or equal to the first threshold and the signal quality of the M candidate cells of the N candidate cells is greater than or equal to the second threshold, the first reference signal is transmitted to one or more of the M candidate cells.

In some embodiments, the method further includes: reporting an identifier of the candidate cell satisfying the first condition to a network device.

For example, M candidate cells satisfy the first condition, and the terminal device transmits the identifiers of the M candidate cells to the network device. The network device selects one or more of the M identifiers of the candidate cells and indicate the selected one or more identifiers to the terminal device. The terminal device transmits the first reference signals to the cells corresponding to the one or more identifiers indicated by the network device.

In some embodiments, the method further includes: receiving a first indication from the network device, wherein the first indication is configured to indicate whether to initiate a random access procedure to the candidate cells satisfying the first condition, and/or to indicate a random access resource.

For example, the first indication indicates that the terminal device initiates a random access procedure (also referred to as RACH, random access, random access procedure, or the like) to all candidate cells satisfying the first condition, and the terminal device transmits a first reference signal, such as a random access preamble, to the M candidate cells satisfying the condition. In addition, the first indication indicates the random access resource used in the random access.

For example, the first indication indicates that the terminal device initiates a random access procedure to some candidate cells, such as cells C1 and C2, of the M candidate cells satisfying the first condition, and the terminal device transmits a random access preamble to cells C1 and C2.

In some embodiments, determining the time advance based on the configuration information of the candidate cells includes: transmitting a first reference signal to a first candidate cell based on the configuration information of the candidate cells and a second indication, wherein the first reference signal is configured to determine the time advance.

In some embodiments, the method further includes:
receiving the second indication, wherein the second indication is carried over a medium access control (MAC) control element (CE) and/or downlink control information (DCI).

In some embodiments of the present disclosure, the second indication and the configuration information of the candidate cells are transmitted simultaneously, or the second indication is transmitted upon transmission of the configuration information of the candidate cells. Accordingly, the terminal device receives the second indication and the configuration information of the candidate cells simultaneously, or receives the second indication and the configuration information of the candidate cells successively. For example, the terminal device receives both the RRC message and the MAC CE simultaneously, wherein the RRC message carries the configuration information of the candidate cells, and the MAC CE carries the second indication. Further, for example, the terminal device receives the RRC message and the DCI successively, wherein the RRC message carries the configuration information of the candidate cell, and the DCI carries the second indication.

In some embodiments, the second indication includes at least one of an identifier of the first candidate cell and a random access resource.

In some embodiments of the present disclosure, at least two of the first timer, the first condition, and the second indication can be combined.

In one implementation, the first timer and the first condition are combined. For example, in the case that the terminal device detects that the first timer times out and the source cell satisfies the first condition, the terminal device transmits a first reference signal to all candidate cells. For example, in the case that the terminal device detects that the first timer times out and the candidate cells satisfy the first condition, the terminal device transmits the first reference signal to the candidate cells satisfying the first condition. Further, for example, in the case that the terminal device detects that the first timer times out and the source cell and the candidate cells satisfy the first condition, the terminal device transmits the first reference signal to the candidate cells satisfying the first condition. For example, the terminal device starts a first timer corresponding to each of the candidate cells, and in the case that the first timer of the candidate cell times out and the candidate cell satisfies the first condition, the first reference signal is transmitted to the candidate cell. In the case that the first timer of a candidate cell times out but the candidate cell does not satisfy the first condition, the first reference signal is not transmitted to the candidate cell.

In one implementation, the first timer and the second indication are combined. For example, in the case that the terminal device detects the first timer timeout and the terminal device receives the second indication, the terminal device transmits the first reference signal to at least one of the candidate cells. Further, for example, the terminal device starts a first timer corresponding to each of the candidate cells, and in the case that the first timer of a candidate cell times out and the terminal device receives the second indication, the terminal device transmits the first reference signal to the candidate cell. In the case that the first timer of a candidate cell times out but and the terminal device receives the second indication, the first reference signal is not transmitted to that candidate cell.

In one implementation, the second indication and the first condition are combined. For example, in the case that the terminal device receives the second indication and the source cell satisfies the first condition, the terminal device transmits the first reference signal to all candidate cells indicated by the second indication. For example, in the case that the terminal device receives the second indication and the candidate cells indicated by the second indication satisfy the first condition, the terminal device transmits the first reference signal to the candidate cells indicated by the second indication satisfying the first condition. For example, in the case that the terminal device receives the second indication and the source cell and the candidate cell indicated by the second indication satisfy the first condition, the terminal device transmits the first reference signal to the candidate cell indicated by the second indication satisfying the first condition.

In one implementation, the first timer, the first condition, and the second indication are combined. For example, in the case that the terminal device detects that the first timer times out, the source cell satisfies the first condition and the terminal device receives the second indication, the terminal device transmits the first reference signal to all candidate cells indicated by the second indication. For example, in the case that the terminal device detects that the first timer times out, the candidate cell satisfies the first condition and the terminal device receives the second indication, the terminal device transmits the first reference signal to the candidate cells indicated by the second indication that satisfy the first condition. For example, in the case that the terminal device detects that the first timer times out, the source cell and the candidate cells satisfy the first condition and the terminal device receives the second indication, the terminal device transmits the first reference signal to the candidate cells indicated by the second indication that satisfy the first condition. For example, the terminal device starts a first timer corresponding to each of candidate cells, and in the case that the first timer of a candidate cell times out, the candidate cell satisfies the first condition and the terminal device receives the second indication, the terminal device transmits the first reference signal to the candidate cell. In the case that the first timer of a candidate cell times out, but the candidate cell does not satisfy the first condition or does not receive the second indication, the first reference signal is not transmitted to the candidate cell.

In some embodiments, the method further includes: listening for a random access response (RAR) window in response to transmitting the first reference signal to receive an RAR, wherein the RAR includes at least one of a time advance, a cell radio network temporary identifier (C-RNTI), or an uplink grant (UL GRANT).

In some embodiments of the present disclosure, a contention-based random access procedure and/or a non-contention-based random access procedure may be adopted. In the case that the terminal device transmits a random access request (may include a random access preamble) to the network, the terminal device can listen for an RAR window to receive an RAR, and the RAR may not carry the UL GRANT.

In some embodiments, the method further includes: listening for a physical downlink control channel (PDCCH) within an RAR window in response to transmitting the first reference signal to receive an RAR, wherein the RAR includes at least one of a time advance, a C-RNTI, or a UL GRANT, wherein the UL GRANT carried in the RAR is used in the case that the terminal device transmits an uplink message to the candidate cell.

In some embodiments, the method further includes: not expecting to receive the RAR upon transmitting the first reference signal. The candidate cell receiving the first reference signal transmits the time advance to the source cell over the Xn interface, such that the source cell carries the time advance when transmitting the handover command. For example, the candidate cell C3receives the first reference signal from the terminal device, and transmits the time advance of the candidate cell determined by using the first reference signal via the Xn interface. In the case that the candidate cell is the target cell for handover, the source cell carries the time advance of the candidate cell when transmitting the handover command to the terminal device.

In some embodiments, the configuration information of the candidate cells includes resource configuration information configured to transmit a first reference signal.

In some embodiments, the first reference signal includes a random access preamble.

In one implementation, the resource configuration information includes a random access resource.

In some embodiments, the random access resource includes at least one of: a beam identifier, a code domain resource, or a time-frequency domain resource.

In some embodiments, the beam identifier includes at least one of a synchronization signal block and PBCH block (SSB) index or a channel state information reference signal (CSI-RS) index.

In some embodiments, the code domain resource includes a preamble index.

In some embodiments, the time-frequency domain resource includes a random access channel (RACH) occasion.

In some embodiments, the random access resource is configured to implicitly indicate that a random access procedure is configured to acquire a handover time advance.

In some embodiments, the random access resource is a specific resource acquired by L1 and/or L2 mobility time advance, and the random access resource is configured to indicate the handover time advance in the random access procedure of L1 and/or L2. For example, in the case that the network receives preamble of the random access resource using L1/L2 mobility time advance acquire specific, it is known that the random access procedure is configured to acquire the time advance of L1 and/or L2 handover.

In some embodiments, the random access resource includes a contention-based random access resource and/or a non-contention-based random access resource.

In some embodiments, the contention-based random access resource is carried over a system message SIB1 of the candidate cell.

In some embodiments, the non-contention-based random access resource includes at least one of:
a RACH resource, an SSB index, or a preamble index.

In some embodiments, the first reference signal includes a sounding reference signal (SRS). For example, in the case that the terminal device transmits the SRS to the candidate cell, the candidate cell transmits the time advance back to the source cell, and the source cell carries the time advance in a handover command transmitted to the terminal device.

In some embodiments, the resource configuration information includes at least one of: a resource identifier, a period, a bandwidth, a time-frequency resource, a transmit port, a path loss reference signal, or a start position.

For example, the resource configuration information in the configuration information of the candidate cells received by the terminal device includes one or more of the resource identifier, the period, the bandwidth, the time-frequency resource, the transmit port, the path loss reference signal, and the start position, and the terminal device transmits the SRS to the one or more candidate cells based on the resource configuration information.

In some embodiments, the configuration information of the candidate cells includes scheduling information of SIB1 and/or SIB9 of the candidate cell.

In some embodiments, the method further includes: receiving the SIB9 of the candidate cell based on the scheduling information. In the embodiment of the present disclosure, the terminal device calculates the time advance itself based on the configuration information of the candidate cells. For example, the terminal device receives the system information, such as the SIB9, of the candidate cell based on the scheduling information of the configuration information of the candidate cells, and then calculates the time advance based on the time information such as the propagation delay.

In some embodiments, the method further includes: triggering the terminal device itself to receive the SIB9 of the candidate cell. In the embodiment of the present disclosure, the terminal device triggers itself to receive the system information, such as the SIB9, of the candidate cell, and then calculates the time advance based on the time information, such as the propagation delay, in the system information.

In some embodiments, the method further includes: determining, based on the third indication of the network device, whether to receive the SIB9 of the candidate cell and/or an identifier of the candidate cell that is required to receive the SIB9.

In some embodiments of the present disclosure, the terminal device receives the third indication from the network device.

The third indication indicates whether the terminal device receives the SIB9 of the candidate cell. In the case that the third indication indicates the terminal device to receive the SIB9 of the candidate cell, the terminal device receives the SIB9 of one or more candidate cells. In the case that the third indication indicates the terminal device not to receive the SIB9 of the candidate cell, the terminal device refuses to receive the SIB9 of the candidate cell.

The third indication also specifically indicates the terminal device to receive the SIB9 of which one or more candidate cells. In the case that the third indication indicates the terminal device to receive the SIB9 of candidate cells C1 and C2, the terminal device receives the SIB9 of candidate cells C1 and C2 and not receives the SIB9 of the other cells.

In some embodiments, the SIB9 includes a coordinated universal time (UTC), and determining the time advance based on the configuration information of the candidate cells includes: determining a propagation delay based on the UTC in the SIB9 and determining the time advance based on the propagation delay. For example, based on the UTC in the SIB9, it is possible to calculate a propagation delay of the SIB9 from the network device to the terminal device. The time advance is equal to twice the propagation delay. The method for calculating the propagation delay includes the time of the terminal device receiving the SIB9 minus the UTC indicated in the SIB9.

In some embodiments, the configuration information of the candidate cells further includes measurement gap (MG) configuration information. In the embodiments of the present disclosure, the MG is also requested by the terminal device. For example, the network is pre-configured with a plurality of sets of MGs, and the terminal device indicates which set of MGs needs to be used over the MAC CE or the DCI. The terminal device uses the MGs or requests the MGs in the case that the terminal device needs to receive a candidate cell system message or transmit random access/SRS to the candidate cell.

In some embodiments, the method further includes: reporting the time advance. For example, upon acquiring the time advance of the candidate cell, the terminal device reports the time advance of the candidate cell to the network device.

In the embodiments of the present disclosure, the candidate cell includes a cell that is selected as a target cell. The quantity of target cells may be multiple or one. In the case that the terminal device needs be switched from the source cell to the target cell, the terminal device selects the target cell itself, or the network side selects the target cell for the terminal device. In some cases, the candidate cells may all be unsuitable as the target cell, and the target cell needs to be selected from cells other than the candidate cells.

In some embodiments, the method further includes: determining, based on a second condition, whether the time advance acquired by the terminal device is valid in response to receiving a handover command.

In the embodiments of the present disclosure, in the case that the terminal device has acquired the time advance prior to receiving the handover command, in response to receiving the handover command, the terminal devices determines, based on the second condition, whether the time advance acquired by the terminal device by using any of the above methods (e.g., by transmitting the first reference signal or the time advance acquired by calculating the time advance based on the UTC in the SIB9) is valid. In the case that the time advance acquired by the terminal device is valid, the time advance may be used in handover, and otherwise, the time advance needs to be reacquired.

In some embodiments, determining, based on the second condition, whether the time advance acquired by the terminal device is valid includes at least one of:
in response to the second condition being satisfied, determining that the time advance acquired by the terminal device is valid; or
in response to the second condition being not satisfied, determining that the time advance acquired by the terminal device is not valid and initiating a random access procedure to reacquire the time advance.

In some embodiments, the second condition includes at least one of the following items:
whether a second timer is in a running state; or
whether a difference between a reference signal received power (RSRP) in response to transmitting the first reference signal and an RSRP in response to receiving the L1 and/or L2 signaling is greater than a third threshold.

For example, the second condition is satisfied in the case that the second timer is in a running state. The second condition is not satisfied in the case that the second timer is not run, suspended, or timed out. For example, the second condition is satisfied in the case that the difference between RSRPI in response to transmitting the first reference signal and RSRP2 in response to receiving the L1 and/or L2 signaling is greater than the third threshold. The second condition is not satisfied in the case that the difference between RSRP1 and RSRP2 is less than or equal to the third threshold. For example, the second condition is satisfied in the case that the second timer is in a running state, and the difference between RSRP1 and RSRP2 is greater than the third threshold.

In some embodiments, the second timer is started in response to the terminal device transmitting the first reference signal. For example, the second timer is started in response to the terminal device transmitting the first reference signal, and during the operation of the second timer, in the case that the terminal device receives a handover command, the time advance acquired by the terminal device using any of the above methods is valid. In the case that the terminal device receives the handover command only upon timeout of the second timer, the time advance acquired by the terminal device using any of the above methods is not valid, and it is necessary to reacquire the time advance.

In some embodiments, the handover command is L1 signaling and/or L2 signaling.

In some embodiments, the handover command is carried over a MAC CE and/or DCI.

In some embodiments, the handover command includes at least one of:
a target cell identifier;
the time advance;
a C-RNTI;
a transmission configuration indication (TCI) state of a dedicated channel and/or a common channel of the terminal device; or
activation and/or deactivation information of a secondary cell (SCELL) and a corresponding TCI state.

In some embodiments, in the case that the handover command received by the terminal device includes the time advance, the terminal device performs handover based on the time advance in the handover command.

In some embodiments, the common channel includes a public PDCCH and/or a public PDSCH.

The TCI state of the dedicated channel of the terminal device includes at least one of: a TCI state of a dedicated PDCCH of the terminal device, a TCI state of a dedicated PDSCH of the terminal device, TCI states of all PUSCHs, and TCI states of all PUCCHs.

In some embodiments, the configuration information of the candidate cells further includes at least one of:
a candidate cell identifier;
a new C-RNTI;
security algorithm information of the candidate cell of a selected security algorithm;
a dedicated random access resource;
an association between a random access resource and an SSB;
an association between a random access resource and a specific CSI-RS configuration of the terminal device;
a public random access resource; or
system information of the candidate cell.

In some embodiments, the time advance includes the time advance of the target cell of the terminal device.

In the method for processing information of the embodiments of the present disclosure, the terminal device is capable of acquiring the time advance of the candidate cell in advance, and thus is capable of acquiring the time advance of the target cell in response to receiving the handover command or prior to receiving the handover command, such that the synchronization between the terminal device and the target cell is realized, and the handover delay is reduced.

FIG. 4 is a schematic block diagram of a terminal device 400 according to some embodiments of the present disclosure. The terminal device 400 includes:
a receiving unit 410, configured to receive configuration information of candidate cells; and
a determining unit 420, configured to determine a time advance time advance based on the configuration information of the candidate cells.

In one implementation, as shown in FIG. 5, in the terminal device 500, the determining unit 420 includes:
a first transmitting subunit 510, configured to transmit a first reference signal to at least one of the candidate cells based on the configuration information of the candidate cells, wherein the first reference signal is configured to determine the time advance.

In some embodiments, the first transmitting sub-unit 510 is configured to transmit the first reference signal to at least one of the candidate cells in the case that a first time period has elapsed since receipt of the configuration information of the candidate cells.

In some embodiments, the first time period is determined by a first timer, wherein a start point of the first time period is a moment that the terminal device starts the first timer in response to receiving the configuration information of the candidate cells, and an end point of the first time period is a moment that the terminal device transmits the first reference signal to at least one of the candidate cells in response to timeout of the first timer.

In some embodiments, each of the candidate cells corresponds to a first timer, and a duration of the first timer is related to a movement trajectory of the terminal device and a coverage of the candidate cell.

In some embodiments, the determining unit 420 includes:
a second transmitting subunit 520, configured to transmit, a first reference signal to at least one of the candidate cells based on the configuration information of the candidate cells and a first condition, wherein the first reference signal is configured to determine the time advance.

In some embodiments, the first condition includes at least one of the following items:
signal quality of a source cell is less than or equal to a first threshold; or signal quality of the candidate cell is greater than or equal to a second threshold.

In some embodiments, the second transmitting sub-unit 520 is configured to perform at least one of:
transmitting the first reference signal to all candidate cells in response to the signal quality of the source cell being less than or equal to the first threshold;
transmitting the first reference signal to candidate cells whose signal quality is greater than or equal to the second threshold in response to the signal quality of the candidate cells being greater than or equal to the second threshold; or
transmitting the first reference signal to candidate cells whose signal quality is greater than or equal to the second threshold in response to the signal quality of the source cell being less than or equal to the first threshold and the signal quality of the candidate cell being greater than or equal to the second threshold.

In some embodiments, the terminal device further includes:
a first reporting unit 430, configured to report an identifier of the candidate cell satisfying the first condition to a network device.

In some embodiments, the receiving unit 410, is further configured to receive a first indication from the network device, wherein the first indication is configured to indicate whether to initiate a random access procedure to the candidate cells satisfying the first condition, and/or, to indicate a random access resource.

In some embodiments, the determining unit 420 includes:
a third transmitting subunit 530, configured to transmit a first reference signal to a first candidate cell based on the configuration information of the candidate cells and a first condition, wherein the first reference signal is configured to determine the time advance.

In some embodiments, the receiving unit 410 is further configured to receive the second indication, wherein the second indication is carried over a MAC CE and/or DCI.

In some embodiments, the second indication includes at least one of an identifier of the first candidate cell or a random access resource.

In some embodiments, the terminal device further includes:
a first listening unit 440, configured to listen for an RAR window in response to transmitting the first reference signal to receive an RAR, wherein the RAR includes at least one of a time advance, a C-RNTI, or an UL GRANT.

In some embodiments, the terminal device further includes:
a second listening unit 450, configured to listen for a physical downlink control channel (PDCCH) within an RAR window in response to transmitting the first reference signal to receive an RAR, wherein the RAR includes at least one of a time advance, a C-RNTI, or a UL GRANT, wherein the UL GRANT carried in the RAR is used in the case that the terminal device transmits an uplink message to the candidate cell.

In some embodiments, the configuration information of the candidate cells includes resource configuration information configured to transmit the first reference signal.

In some embodiments, the first reference signal includes a random access preamble.

In some embodiments, the resource configuration information includes a random access resource.

In some embodiments, the random access resource includes at least one of: a beam identifier; a code domain resource; or a time-frequency domain resource.

In some embodiments, the beam identifier includes at least one of an SSB index or a CSI-RS index.

In some embodiments, the code domain resource includes a preamble index.

In some embodiments, the time-frequency domain resource includes a random access channel occasion.

In some embodiments, the random access resource is configured to implicitly indicate that a random access procedure is configured to acquire a handover time advance.

In some embodiments, the random access resource is specific resources acquired by Layer 1 (L1) and/or Layer 2 (L2) mobility time advance, and the random access resource is configured to indicate the handover time advance in the random access procedure for L1 and/or L2.

In some embodiments, the random access resource includes a contention-based random access resource and/or a non-contention-based random access resource.

In some embodiments, the contention-based random access resource is carried over a system message SIB1 of the candidate cell.

In some embodiments, the non-contention based random access resource includes at least one of: a RACH resource, an SSB index, or a preamble index.

In some embodiments, the first reference signal includes an SRS.

In some embodiments, the resource configuration information includes at least one of: a resource identifier, a period, a bandwidth, a time-frequency resource, a transmit port, a path loss reference signal, or a start position.

In some embodiments, the configuration information of the candidate cells includes scheduling information of SIB1 and/or SIB9 of the candidate cell.

In some embodiments, the receiving unit 410 is further configured to receive the SIB9 of the candidate cell based on the scheduling information.

In some embodiments, the receiving unit 410 is further configured to trigger the terminal device itself to receive the SIB9 of the candidate cell.

In some embodiments, the determining unit 420 is further configured to determine, based on a third indication of a network device, whether to receive the SIB9 of the candidate cell and/or an identifier of the candidate cell that is required to receive the SIB9.

In some embodiments, the SIB9 includes a UTC, and the determining unit 420 is further configured to determine a propagation delay based on the UTC in the SIB9 and to determine the time advance based on the propagation delay.

In some embodiments, the configuration information of the candidate cells further includes measurement gap configuration information.

In some embodiments, the terminal device further includes a second reporting unit 460, configured to report the time advance.

In some embodiments, the determining unit 420 is further configured to determine, the terminal device, whether the time advance acquired by the terminal device is valid in response to receiving a handover command.

In some embodiments, the determining unit 420 is further configured to perform at least one of:
in response to the second condition being satisfied, determining that the time advance acquired by the terminal device is valid; or
in response to the second condition being not satisfied, determining that the time advance acquired by the terminal device is not valid, and initiating a random access procedure to reacquire the time advance.

In some embodiments, the second condition includes at least one of the following items:
whether a second timer is in a running state; or
whether a difference between an RSRP in response to transmitting the first reference signal and an RSRP in response to receiving the L1 and/or L2 signaling is greater than a third threshold.

In some embodiments, the second timer is started in response to the terminal device transmitting the first reference signal.

In some embodiments, the handover command is L1 signaling and/or L2 signaling.

In some embodiments, the handover command is carried over a MAC CE and/or DCI.

In some embodiments, the handover command includes at least one of:
a target cell identifier;
the time advance;
a C-RNTI;
a TCI state of a dedicated channel and/or a common channel of the terminal device; or
activation and/or deactivation information of a SCELL and a corresponding TCI state.

In some embodiments, the common channel includes a public PDCCH and/or a public PDSCH.

The TCI state of the dedicated channel of the terminal device includes at least one of: a TCI state of a dedicated PDCCH of the terminal device, a TCI state of a dedicated PDSCH of the terminal device, TCI states of all PUSCHs, and TCI states of all PUCCHs.

In some embodiments, the configuration information of candidate cells further includes at least one of:
a candidate cell identifier;
a new C-RNTI;

security algorithm information of the candidate cell of a selected security algorithm;
a dedicated random access resource;
an association between a random access resource and an SSB;
an association between a random access resource and a specific CSI-RS configuration of the terminal device;
a public random access resource; or
system information of the candidate cell.

In some embodiments, the time advance includes a time advance of a target cell of the terminal device.

The terminal devices 400, 500 in the embodiments of the present disclosure are capable of implementing the corresponding functions of the terminal devices in the above embodiments of the method 300. The corresponding processes, functions, implementations, and beneficial effects of the individual modules (sub-modules, units or components, or the like) in the terminal device 400, 500 can be found in the corresponding descriptions in the above method embodiments, which are not repeated herein. It is to be noted that the functions described with respect to the individual modules (sub-modules, units or components, or the like) in the terminal devices 400, 500 of the application embodiments can be implemented by different modules (sub-modules, units or components, or the like), or implemented by the same module (sub-module, unit or component, or the like).

Example I Transmitting a preamble to all candidate cells in an RRC reconfiguration message:

The terminal receives a candidate cell configured by the network, and a candidate cell configuration includes at least one of: a candidate cell identifier, a new C-RNTI, candidate cell security algorithm information of a selected security algorithm, a dedicated RACH resource, an association between the RACH resource and the SSB, an association between the RACH resource and a terminal device-specific CSI-RS configuration, a public RACH resource, or system information of the candidate cell.

The terminal transmits a first reference signal (e.g., a preamble or an SRS) to the at least one of the candidate cells, and the first reference signal is configured to determine a time advance of the terminal. The at least one of the candidate cells includes all or some of the candidate cells of the network configuration. For example, the terminal transmits the first reference signal to all candidate cells in the configuration upon receiving a candidate cell configuration from the network side.

Optionally, the terminal transmits the first reference signal to all candidate cells in the case that a first time period (when the first timer times out) has elapsed since receipt of the candidate cell configuration on the network side. For example, the terminal starts the first timer upon receiving the configuration information from the network side (information for configuring the candidate cells), and in the case that the first timer times out, the terminal transmits the first reference signal to all the candidate cells. The configuration granularity of the timer may be per candidate cell. That is, cach candidate cell maintains a corresponding first timer. For a terminal with a particular trajectory, the network triggers transmission of the first reference signal in the case that the terminal is about to reach/has just reached the coverage of the cell. That is, the duration of the first timer is related to the movement trajectory of the terminal and the coverage of the candidate cell.

Further, the terminal transmits the first reference signal to the at least one candidate cell through a random access procedure, that is, the first reference signal is a random access preamble. The random access procedure may be a contention-based random access or a non-contention-based random access. The type of the random access procedure includes two-step or four-step random access. The random access resource used in the random access is L1 and/or L2 mobility time advance acquire specific, such that upon receipt of the preamble transmitted by the terminal, the network knows that the random access procedure is initiated for acquiring a time advance for LI and/or L2 handover.

The configuration information further includes resource configuration information for transmitting the first reference signal. In the case that the first reference signal is a preamble, the resource configuration information is a random access resource, which includes, for example, at least one of a beam identifier (SSB/CSI-RS index), a code domain resource (preamble index), or a time-frequency domain resource (RACH occasion).

The relevant configuration and resources used for the random access procedure may be determined in the following ways.

Option 1: The network carries the configuration when configuring the candidate cell, that is, the configuration information of the candidate cells includes a random access-related configuration. The random access-related configuration may be a contention random access resource such as the SIB1 of the candidate cell. The random access-related configuration may also be a non-contention-based random access resource, and the network may carry the RACH resource, an SSB index, a preamble index, or the like in the candidate cell configuration.

Option 2: The terminal determines a candidate cell satisfying the conditions and reports the candidate cell to the network, and the network notifies the terminal whether to initiate a random access procedure and/or a random access resource to the cell.

In the case that the random access procedure is non-contention random access, the terminal performs at least one of the following options.

Option 1: Upon transmitting the first reference signal, the terminal does not expect to receive an RAR from the candidate cell, that is, the candidate cell transmits the acquired time advance to the source cell over the Xn interface upon receiving the first reference signal from the terminal, such that the source cell carries the time advance when transmitting the handover command.

Option 2: Upon transmitting the first reference signal, the terminal listens for the RAR window normally to receive an RAR, wherein the RAR does not carry a UL grant.

Option 3: Upon transmitting the first reference signal, the terminal listens for the PDCCH in the RAR window normally to receive an RAR, wherein a UL grant carried in the RAR may be used for the UE to subsequently transmit an uplink message to the target network.

In addition, in the case that the first reference signal is an SRS, the resource configuration information of the first reference signal includes one or more of a resource identifier, a period, a bandwidth, a time-frequency resource, a transmit port, a path loss reference signal, a start position, and the like.

Further, the terminal receives the handover command transmitted by the network and performs the cell handover. The handover command may be L1 and/or L2 signaling, such as a MAC CE or a DCI. The handover command includes an identifier of the target cell, a time advance (which may not be carried in the case that the UE calculates and acquires it itself), a C-RNTI, a common PDCCH/PDSCH, and/or a TCI state of UE-dedicated channels (UE-dedicated PDCCH/PDSCH and all PUSCH/PUCCH), SCELL activation de-activation information, and the corresponding TCI state. The handover procedure is also applicable to following Examples 2 to 5.

Example 2, Condition-based:

The terminal receives a candidate cell configuration from the network, and a first condition information of the network configuration. The first condition includes a source cell threshold and/or a candidate cell threshold. Transmitting a first reference signal (e.g., preamble) to the candidate cell by the terminal based on the first condition includes the following processes.

In response to the candidate cell satisfying the first condition of the network configuration, the terminal transmits the first reference signal to the cell. That is, the terminal listens for the signal strength of all candidate cells of the network configuration, and in the case that a candidate cell threshold is satisfied (e.g., the signal quality of the candidate cell is greater than or equal to the candidate cell threshold), the terminal transmits the first reference signal to the candidate cell satisfying the condition.

In response to the source cell satisfying the first condition of the network configuration, the terminal transmits the first reference signal to the candidate cell. That is, the terminal listens for the signal strength of the source cell. In the case that the source cell threshold is satisfied (for example, the signal quality of the source cell is less than or equal to the source cell threshold), the terminal transmits the first reference signal to all the candidate cells.

In response to the source cell and the candidate cells satisfying the first condition of the network configuration simultaneously, the terminal transmits the first reference signal to a candidate cell (e.g., a candidate cell whose signal quality is greater than or equal to the candidate cell threshold).

Optionally, prior to the terminal transmitting the first reference signal to the candidate cell, the terminal indicates the network side the information of the candidate cell of the first reference signal to be transmitted by the terminal.

The first condition includes a cell channel quality, for example, at least one of RSRP, RSRQ, SINR, or the like. The first condition is a relative condition or an absolute condition. For example, the absolute condition includes a comparison of the cell channel quality with a specific threshold. The relative condition includes a comparison of an amount of change in the cell channel quality with a specific threshold.

Further, the terminal transmits the first reference signal to the candidate cell satisfying the condition through a random access procedure, that is, the first reference signal is a random access preamble. The random access procedure is a contention-based random access or a non-contention random access. The type of the random access procedure includes 2-step or 4-step random access, and the random access resource used for the random access is L1/L2 mobility time advance acquire specific. In this way, the network knows that the random access procedure is configured to acquire a time advance for L1 and/or L2 handover in the case that the network receives the preamble from the terminal.

The associated configuration and resource used by the random access procedure can be determined in the following manners.

Option 1: The network carries the configuration in the case that the candidate cell is configured, that is, the configuration information of the candidate cells includes a random access-related configuration. The configuration may be a contention random access resource such as the SIB1 of the candidate cell. The configuration may also be a non-contention-based random access resource, and the network may carry the RACH resource, the SSB index, the preamble index, or the like in the candidate cell configuration.

Option 2: The terminal determines a candidate cell satisfying the conditions and reports the candidate cell to the network side, and the network notifies the terminal whether to initiate a random access procedure and/or a random access resource to the cell.

In the case that the random access procedure is non-contention random access, the terminal performs at least one of the following options.

Option 1: Upon transmitting the first reference signal, the terminal does not expect to receive the RAR from the candidate cell, that is, the candidate cell transmits the acquired time advance to the source cell over the Xn interface upon receiving the first reference signal from the terminal, such that the source cell carries the time advance when transmitting the handover command.

Option 2: Upon transmitting the first reference signal, the terminal normally listens for the RAR window to receive an RAR without a UL Grant.

Option 3: Upon transmitting the first reference signal, the terminal normally listens for the PDCCH in the RAR window to receive an RAR, wherein a UL grant carried in the RAR may be used for the UE for subsequently transmit an uplink message to the target network.

### Example 3

The terminal receives a candidate cell configuration and an indication message from the network. The indication message is configured to indicate the terminal to transmit a first reference signal to the candidate cell. The terminal transmits the first reference signal to the candidate cell based on the network indication. The indication information is transmitted simultaneously with the candidate cell configuration or later than the configuration information of the candidate cells. The indication information is a MAC CE or DCI and includes, for example, candidate cell identifiers and/or RACH resources.

The terminal transmits the first reference signal to the candidate cell indicated by the network through a random access procedure, that is, the first reference signal is a random access preamble. The random access procedure is a contention-based random access or a non-contention-based random access. The type of the random access procedure includes a 2-step or a 4-step random access, and the RACH resource used for the random access is L1/L2 mobility time advance acquire specific, such that the network knows that the random access procedure is configured to acquire a time advance for L1 and/or L2 handover in the case that the network receives the preamble from the terminal.

### Example 4

The terminal receives configuration information of candidate cells, and the candidate cell configuration information includes scheduling information of SIB1 and/or SIB9 of the candidate cell. The terminal receives the SIB9 of the candidate cell based on the scheduling information, and optionally, the configuration information includes measurement gap configuration information.

The SIB9 includes a UTC time, and the terminal determines the time advance by determining a propagation delay based on the UTC time of the system message broadcast for the candidate cell.

For L1 and/or L2 mobility (intra-CU scenarios), it may be considered that the UTC times on the terminal and base station side are already synchronized.

The terminal determines the propagation delay (PD) by receiving the SIB9 of the candidate cell. Because time advance=2*PD, and the time advance may be determined based on the PD.

The reception of the SIB9 of the candidate cell by the UE may be triggered by the UE itself, e.g., in combination with Example 1 or 2, the UE may receive the SIB9 of at least one candidate cell. Alternatively, the terminal determines, based on the network indications, whether to receive the SIB9 of the candidate cell, and further determines, based on the network indications, to receive the SIB9 of which candidate cell.

Optionally, the terminal indicates a value of the time advance on the network side upon determining the time advance.

The SIB9 is described as follows.

The SIB9 contains information related to GPS time and UTC. The UE uses the parameters provided in this system information block to acquire UTC, GPS and local time.

NOTE: The UE uses the time information for numerous purposes, possibly involving upper layers, e.g. to assist initial GPS initialization, to synchronize the UE clock. See the below example of a SIB9 information element, the UTC is retrieved from a UTC time information field of the SIB9 such as time Info UTC.

An example of a SIB9 information element is shown below:

ASN1START
TAG-SIB9-START

| | |
|---|---|
| SIB9 ::= | SEQUENCE { |
| timeInfo | SEQUENCE { |

| timeInfoUTC | INTEGER (0..549755813887) , | |
|---|---|---|
| dayLightSavingTime | BIT STRING (SIZE (2)) | OPTIONAL, -- |
| Need R | | |

| | | |
|---|---|---|
| leapSeconds | INTEGER (−127..128) | OPTIONAL, -- Need R |

| localTimeOffset | INTEGER (−63..64) | OPTIONAL -- Need R |
|---|---|---|
| } | OPTIONAL, -- Need R | |
| lateNonCriticalExtension | OCTET STRING | OPTIONAL, |
| ..., | | |
| [[ | | |
| referenceTimeInfo-r16 | ReferenceTimeInfo-r16 | OPTIONAL -- |
| Need R | | |
| ]] | | |
| } | | |
| TAG-SIB9-STOP | | |
| ASN1STOP | | |

In addition, examples of some of the field descriptions of the SIB9 are shown below:

SIB9 field descriptions

Day Light Saving Time
Indicates if and how daylight-saving time (DST) is applied to obtain
the local time. The semantics are the same as the semantics of the
Daylight Saving Time IE in TS 24.501 [23] and TS 24.008 [38]. The
first/leftmost bit of the bit string contains the b2 of octet 3 and
the second bit of the bit string contains b1 of octet 3 in the value
part of the Daylight Saving Time IE in TS 24.008 [38].
Leap Seconds
Number of leap seconds offset between GPS Time and UTC. UTC and
GPS time are related i.e. GPS time − leap Seconds = UTC time.
Local Time Offset
Offset between UTC and local time in units of 15 minutes. Actual
value = field value * 15 minutes. Local time of the day is calculated
as UTC time + local Time Offset.
Time Info UTC
Coordinated Universal Time corresponding to the SFN boundary at or
immediately after the ending boundary of the SI-window in which SIB9
is transmitted. The field counts the number of UTC seconds in 10 ms
units since 00:00:00 on Gregorian calendar date 1 Jan. 1900
(midnight between Sunday, Dec. 31, 1899 and Monday, Jan. 1, 1900).

### Example 5

Based on the above examples 1-4, in order to ensure the effectiveness of the time advance in the case that the terminal performs L1 and/or L2 handover, the scheme further includes the following content:

the terminal determines whether one of the following conditions is satisfied in response to receiving the L1 and/or L2 handover command. In the case that one of the following conditions is satisfied, the time advance determined by transmitting the first reference signal under the target cell is valid. Otherwise, it is necessary to acquire a valid time advance by reinitiating RACH to the target cell:
the terminal starts the second timer upon transmitting the first reference signal to each target cell, and the second timer is started for each target cell. During the operation period of the second timer, in the case that the terminal receives L1 and/or L2 signaling and indicates that the terminal switches to the corresponding target cell, the terminal determines whether to initiate a random access procedure under the target cell to acquire the time advance based on the following conditions:
the second timer is in operation; and

the terminal compares whether the difference between the RSRP at the time of transmission of the first reference signal and the RSRP at the time of receipt of the L1 and/or L2 signaling is greater than a specific pre-configured threshold.

In the case that one of the above conditions is not satisfied, the terminal is required to initiate a random access procedure to acquire a valid time advance when handing over to the target cell. Otherwise, the terminal determines the valid time advance based on the scheme in Examples 1 to 4.

The above examples 1 to 5 are applicable to inter-frequency, intra-frequency, synchronous or asynchronous scenarios. In addition, at least two of Examples 1, 2 and 3 may be combined, and Example 5 may be combined with any one or more of Examples 1 to 4.

The method for processing information according to the embodiments of the present disclosure is a method for acquiring a time advance in advance. In some embodiments, the method for acquiring time advance in advance includes: the terminal initiating a RACH to the at least one candidate cell based on the candidate cell configuration, referring to Example 1. In some embodiments, the method for acquiring time advance in advance includes: initiating, by the terminal, a RACH to the at least one candidate cell based on conditions, referring to Example 2. In some embodiments, the method for acquiring time advance in advance includes: initiating, by the terminal a RACH to the at least one candidate cell based on a network indication, referring to Example 3. In some embodiments, the method for acquiring the time advance in advance include: determining, by the terminal, the time advance based on a UTC time of a system message broadcast, referring to Example 4.

Based on the embodiments of the present disclosure, the terminal acquires the time advance of the target cell in advance, such that the handover delay is reduced.

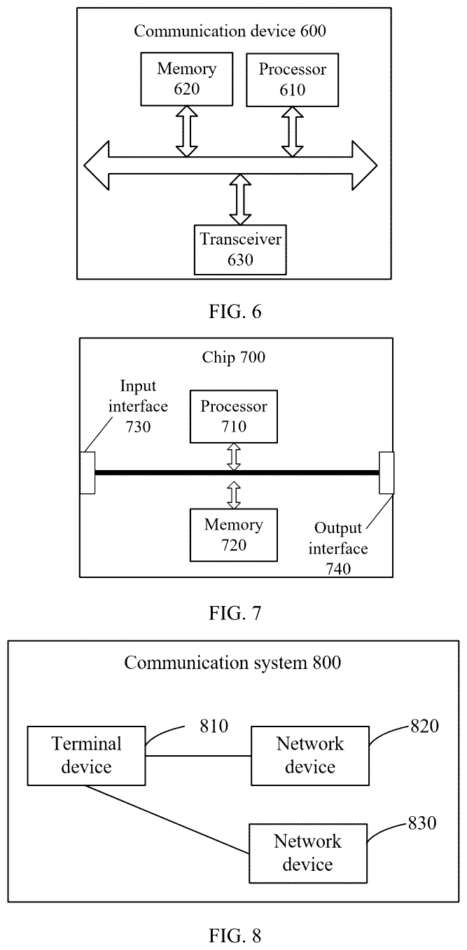

FIG. 6 is a schematic structural diagram of a communication device 600 according to some embodiments of the present disclosure. The communication device 600 includes a processor 610, and the processor 610, when loading and running a computer program from memory, causes the communication device 600 to perform the method in the embodiments of the present disclosure.

In one possible implementation, the communication device 600 further includes a memory 620. The processor 610, when loading and running the computer programs from the memory 620, causes the communication device 600 to perform the methods in the embodiments of the present disclosure.

The memory 620 may be a device separate from the processor 610 or may be integrated into the processor 610.

In one possible implementation, the communication device 600 further includes a transceiver 630. The processor 610 can control the transceiver 630 to communicate with other devices, specifically, to transmit information or data to other devices, or to receive information or data transmitted by other devices.

The transceiver 630 includes a transmitter and a receiver. The transceiver 630 further includes an antenna, and the quantity of antennas may be one or more.

In one possible implementation, the communication device 600 may be a network device in some embodiments of the present disclosure, and the communication device 600 may perform the corresponding processes implemented by the network device in the various methods in the embodiments of the present disclosure, which are not repeated herein for brevity.

In one possible implementation, the communication device 600 may be a terminal device according to the embodiments of the present disclosure, and the communication device 600 may perform the corresponding processes implemented by the terminal device in the various methods in the embodiments of the present disclosure, which are not repeated herein for brevity.

FIG. 7 is a schematic structural diagram of a chip 700 according to some embodiments of the present disclosure. The chip 700 includes a processor 710. The processor 710, when loading and running a computer program from memory, causes a device to perform the methods in the embodiments of the present disclosure.

In one possible implementation, the chip 700 further includes a memory 720. The processor 710, when loading and running the computer program from the memory 720, causes the terminal device or the network device to perform the method in the embodiments of the present disclosure.

The memory 720 may be a device separate from the processor 710 or may be integrated into the processor 710.

In one possible implementation, the chip 700 further includes an input interface 730. The processor 710 controls the input interface 730 to communicate with other devices or chips, specifically, to acquire information or data transmitted by other devices or chips.

In one possible implementation, the chip 700 further includes an output interface 740. The processor 710 controls the output interface 740 to communicate with other devices or chips, specifically, to output information or data to other devices or chips.

In one possible implementation, the chip is applicable to a network device in the embodiments of the present disclosure, and the chip can perform the corresponding processes implemented by the network device in the various methods in the embodiments of the present disclosure, which are not repeated herein for brevity.

In a possible implementation, the chip is applicable to the terminal device in the embodiments of the present disclosure, and the chip can perform the corresponding processes implemented by the terminal device in the methods in the embodiments of the present disclosure, which are not repeated herein for brevity.

The chips applicable to the network device and the terminal device can be the same chip or different chips.

It is understandable that the chips in the embodiments of the present disclosure may also be referred to as system-level-chip, system-chip, chip-system, or system-on-chip, or the like.

The above processor may be a general purpose processor, a digital signal processor (DSP), a field programmable gate array (FPGA), an application specific integrated circuit (ASIC) or other programmable logic devices, transistor logic devices, discrete hardware components, and the like. The above general-purpose processor may be a microprocessor or any conventional processor, or the like.

The above memory may be transitory memory or non-transitory memory or may include both transitory and non-transitory memory. The non-transitory memory may be a read-only memory (ROM), a programmable read-only memory (PROM), an erasable programmable read-only memory (EPROM), an electrically erasable programmable read-only memory (EEPROM), or a flash memory. The transitory memory may be a random access memory (RAM).

It is understandable that the above memories are exemplary, but not limiting. For example, the memories in the embodiments of the present disclosure may also be static RAM (SRAM), dynamic RAM (DRAM), synchronous DRAM (SDRAM), dual data rate SDRAM (DDR SDRAM), enhanced SDRAM (ESDRAM), synch link DRAM (SLDRAM), direct Rambus RAM (DR RAM), and the like. That is, the memory in the embodiments of the present disclosure is intended to include, but is not limited to, these and any other suitable types of memory.

FIG. 8 is a schematic block diagram of a communication system 800 according to some embodiments of the present disclosure. The communication system 800 includes: a terminal device 810, configured to receive configuration information of a candidate cell, and determine a time advance based on the configuration information of the candidate cells. The terminal device 810 is used to perform the corresponding functions implemented by the terminal device in the above method, which are not repeated herein for brevity.

In some embodiments, the communication system further includes a first network device 820, configured to transmit the configuration information of the candidate cells to the terminal device 810. The network device 820 is configured to perform the corresponding functions implemented by the source cell in the above method, which are not repeated herein for brevity.

In some embodiments, the communication system further includes a second network device 830, configured to transmit the first reference signal to the receiving terminal device 810. The network device 830 is used to perform the corresponding functions implemented by the candidate cell in the above method, which are not repeated here for brevity.

In the above embodiments, the embodiments can be implemented in whole or in part by software, hardware, firmware, or any combination thereof. In the case that the embodiments are implemented by software, the embodiments may be implemented wholly or partially in the form of a computer program product. The computer program product includes one or more computer instructions. The one or more computer instructions, when loaded and executed by a computer, produce, in whole or in part, a process or function according to the embodiments of the present disclosure. The computer may be a general purpose computer, a special purpose computer, a computer network, or other programmable device. The computer instructions can be stored in a computer-readable storage medium or transmitted from one computer-readable storage medium to another computer-readable storage medium. For example, the computer instructions are transmitted from a web site, computer, server, or data center via a wired (e.g., coaxial cable, fiber optic, digital subscriber line) or wireless (e.g., infrared, wireless, microwave, or the like.) to another website site, computer, server, or data center. The computer-readable storage medium can be any usable medium to which a computer has access or a data storage device such as a server, data center, or the like. that contains one or more usable media integrated. The usable medium can be a magnetic medium, (e.g., floppy disk, hard drive, tapc), an optical medium (e.g., DVD), or a semiconductor medium (e.g., solid state disk, SSD), and the like.

It is understandable that in various embodiments of the present disclosure, the value of the serial number of each of the above processes does not imply the order of execution, and the order of execution of each of the processes should be determined by its function and inherent logic without constituting any limitation of the process of implementation of the embodiments of the present disclosure.

It is clearly understood by those skilled in the art that, for the convenience and brevity of the description, the specific working processes of the above systems, devices, and units can be referred to the corresponding processes in the above embodiments of the method, and are not repeated herein.

Described above are merely specific embodiments of the present disclosure, but the scope of protection of the present disclosure is not limited thereto. Any changes or substitutions that can be readily thought of by any person skilled in the art within the scope of the art disclosed in the present disclosure shall be covered by the scope of protection of the present disclosure. Therefore, the scope of protection of this application shall be subject to the scope of protection of the claim.

What is claimed is:

1. A method for processing information, applicable to a terminal device, the method comprising:
receiving configuration information of candidate cells; and
determining a time advance based on the configuration information of the candidate cells.

2. The method according to claim 1, wherein determining the time advance based on the configuration information of the candidate cells comprises:
transmitting a first reference signal to a first candidate cell based on the configuration information of the candidate cells and a second indication, wherein the first reference signal is configured to determine the time advance.

3. The method according to claim 2, further comprising:
receiving the second indication, wherein the second indication is carried over a medium access control (MAC) control element (CE) and/or downlink control information (DCI).

4. The method according to claim 2, wherein the second indication comprises at least one of an identifier of the first candidate cell or a random access resource.

5. The method according to claim 1, wherein the configuration information of candidate cells comprises resource configuration information configured to transmit a first reference signal.

6. The method according to claim 5, wherein the first reference signal comprises a random access preamble.

7. The method according to claim 6, wherein the resource configuration information comprises a random access resource.

8. The method according to claim 7, wherein the random access resource comprises at least one of:
a beam identifier;
a code domain resource; or
a time-frequency domain resource.

9. The method according to claim 7, wherein the random access resource comprises a contention-based random access resource and/or a non-contention-based random access resource.

10. The method according to claim 1, further comprising:
in response to receiving a handover command, determining, based on a second condition, whether the time advance acquired by the terminal device is valid.

11. The method according to claim 10, wherein the handover command comprises at least one of:
a target cell identifier;
the time advance;
a cell radio network temporary identifier (C-RNTI);
a transmission configuration indication (TCI) state of a dedicated channel and/or a common channel of the terminal device; or
activation and/or deactivation information of a secondary cell (SCELL) and a corresponding TCI state.

12. The method according to claim 1, wherein the configuration information of the candidate cells further comprises at least one of:
a candidate cell identifier;
a new cell radio network temporary identifier (C-RNTI);
security algorithm information of the candidate cell of a selected security algorithm;
a dedicated random access resource;
an association between a random access resource and a synchronization signal block and PBCH block (SSB);
an association between a random access resource and a specific channel state information reference signal (CSI-RS) configuration of the terminal device;
a public random access resource; or
system information of the candidate cell.

13. The method according to claim 1, wherein the time advance comprises a time advance of a target cell of the terminal device.

14. A terminal device, comprising:
a processor; and
a memory, storing one or more computer programs, which, when executed by the processor, cause the terminal device to:
receive configuration information of candidate cells; and
determine a time advance based on the configuration information of the candidate cells.

15. The terminal device according to claim 14, wherein the one or more computer programs, when executed by the processor, further cause the terminal device to:
transmit a first reference signal to a first candidate cell based on the configuration information of the candidate cells and a second indication, wherein the first reference signal is configured to determine the time advance.

16. The terminal device according to claim 15, wherein the one or more computer programs, when executed by the processor, further cause the terminal device to:
receive the second indication, wherein the second indication is carried over a medium access control (MAC) control element (CE) and/or downlink control information (DCI).

17. The terminal device according to claim 15, wherein the second indication comprises at least one of an identifier of the first candidate cell or a random access resource.

18. The terminal device according to claim 14, wherein the configuration information of candidate cells comprises resource configuration information configured to transmit a first reference signal.

19. The terminal device according to claim 18, wherein the first reference signal comprises a random access preamble.

20. A chip, comprising a processor, wherein the processor is configured to execute one or more computer programs stored from a memory, which causes a device equipped with the chip to:
receive configuration information of candidate cells; and
determine a time advance based on the configuration information of the candidate cells.
